(19) United States
(12) Patent Application Publication
(10) Pub. No.: US 2024/0294688 A1
(43) Pub. Date: Sep. 5, 2024

(54) COMPOSITION FOR 3D-PRINTING, 3D-PRINTED OBJECT FORMED THEREFROM AND PROCESS FOR FORMING THE SAME

(71) Applicant: BASF SE, Ludwigshafen am Rhein (DE)

(72) Inventors: Zhi Zhong CAI, Shanghai (CN); Wei Zheng FAN, Shanghai (CN); Yan Sheng LI, Shanghai (CN)

(21) Appl. No.: 18/572,212

(22) PCT Filed: Jun. 15, 2022
(86) PCT No.: PCT/EP2022/066329

§ 371 Date: Dec. 20, 2023

(30) Foreign Application Priority Data
Jun. 24, 2021 (WO) PCT/CN2021/102095

(51) Int. Cl. C08F 290/06; B33Y 70/00; B33Y 80/00; C08F 2/50

(52) U.S. Cl. CPC C08F 290/067; B33Y 70/00; B33Y 80/00; C08F 2/50

(57) ABSTRACT

The present invention relates to a curable composition for 3D-printing, which comprises: (A) at least one reactive component: (B) at least one physical volatile agent; and (C) at least one photoinitiator, a process of forming a 3D-printed object from the same and a 3D-printed object prepared therefrom. The 3D-printed object formed from the composition has reduced density, stable dimension size, and uniform porous structure.

### TECHNICAL FIELD

The present invention relates to a composition for three-dimensional (hereinafter referred to as “3D”) printing, in particular to a curable composition, more particularly a radiation-curable composition, for 3D printing. The present invention also relates to a process of forming a 3D-printed object by using the composition, and a 3D-printed object formed therefrom.

### BACKGROUND

3D-printing technologies, e.g., stereolithography (SLA), digital light processing (DLP) and photopolymer jetting (PPJ), have been used in many applications, e.g., rapid prototyping, manufacturing of hearing aids, manufacturing of dental parts. Photopolymers can be 3D-printed by technologies such as SLA, DLP and PPJ through photo-initiated polymerization triggered by UV or visible light. However, it is a huge challenge to reduce density of 3D-printed objects, and lightweight of 3D-printable materials is one of challenges for photocurable materials due to the organic chemical composition of their general component. On the other hand, it is difficult to obtain printed objects with porous structure based on photopolymer since the 3D-printing process cannot control uniform porous structure and may let uncurable resin out of printed objects. Moreover, lightweight of material achieved by introduction of hollow fillers in the resin is not suitable for photocurable resin due to poorer resin compatibility and stability.

Therefore, there is a strong need to develop a class of 3D-printable materials to enable successful formation of lightweight and porous objects in 3D-printing process by technologies such as SLA, DLP or PPJ.

### SUMMARY OF THE INVENTION

It is an object of the invention to provide a curable composition comprising a physical volatile agent for 3D-printing, wherein the 3D-printed object formed from the composition exhibits low density and uniform porous structure.

Another object of the present invention is to provide a 3D-printed object formed from the curable composition of the present invention.

A further object of the present invention is to provide a process of forming 3D-printed object by using the curable composition of the present invention.

It has been surprisingly found that the above objects can be achieved by following embodiments:

1. A curable composition for 3D-printing, which comprises:
(A) at least one reactive component;
(B) at least one physical volatile agent; and
(C) at least one photoinitiator.

2. The composition according to item 1, wherein the reactive component (A) contains at least one radiation-curable functional group.

3. The composition according to item 2, wherein the radiation-curable functional group is selected from the group consisting of an ethylenically unsaturated functional group, an epoxy group, or the mixture thereof, preferably the radiation-curable functional group is an ethylenically unsaturated functional group.

4. The composition according to item 2 or 3, wherein the number of the radiation-curable functional group in the reactive component (A) is in the range from 1 to 12, preferably from 1 to 10, more preferably from 1 to 8, per molecule of the reactive component (A).

5. The composition according to any one of items 1 to 4, wherein the reactive component (A) contains at least one ethylenically unsaturated functional group selected from the group consisting of allyl, vinyl, acrylate, methacrylate, acryloxy, methacryloxy, acrylamido, methacrylamido, acetylenyl, and maleimido.

6. The composition according to any one of items 1 to 4, wherein the reactive component (A) comprises epoxidized olefins, aromatic glycidyl ethers, aliphatic glycidyl ethers, or any combination thereof.

7. The composition according to any one of items 1 to 6, wherein the physical volatile agent (B) is soluble solid physical volatile agent and/or liquid physical volatile agent having a boiling point of more than 0° C. at ambient pressure; preferably the physical volatile agent (B) is liquid physical volatile agent having a boiling point of more than 0° C. at ambient pressure; more preferably the physical volatile agent (B) is selected from alkanes; cycloalkanes; acyclic or cyclic ethers; ketones; alkyl carboxylates; halogenated alkanes; or any combination thereof.

8. The composition according to item 7, wherein the boiling point of the liquid physical volatile agent is more than 25° C., preferably less than 200° C.

9. The composition according to any one of items 1 to 8, wherein the physical volatile agent (B) comprises C₄₋₁₀-alkanes, preferably pentane, hexane, heptane, and octane, more preferably heptane; C₄₋₁₀-cyclo-alkanes, preferably cyclopentane, and cyclohexane; C₄₋₆-cyclic ethers, preferably furan; di-C₁₋₅-alkyl ether, preferably dimethyl ether and diethyl ether; C₄₋₁₀-cyclo-alkylene ethers; C₁₋₅-ketones, preferably acetone, methyl ethyl ketone; C₁₋₈-alkyl carboxylates, preferably methyl formate, and ethyl acetate; dimethyl oxalate; halogenated C₁₋₆-alkanes, preferably methylene chloride, trichloromethane, dichloromonofluoromethane, 1, 1-dichloro-2,2,2-trifluoroethane, 2,2-dichloro-2-fluoroethane, dichlorobutane, and 1,5-dichloropentane; or any combination thereof.

10. The composition according to any one of items 1 to 9, wherein the photoinitiator (C) is a free radical photoinitiator and/or an ionic photoinitiator, preferably free radical photoinitiator.

11. The composition according to any one of items 1 to 10, wherein the amount of the reactive component (A) is in the range from 10 to 99.8% by weight, preferably from 20 to 98.9% by weight, more preferably from 50 to 95% by weight, based on the total weight of the composition.

12. The composition according to any one of items 1 to 11, wherein the amount of the physical volatile agent (B) is in the range from 0.1 to 50% by weight, preferably from 1 to 40% by weight, more preferably from 1 to 20% by weight, based on the total weight of the composition.

13. The composition according to any one of items 1 to 12, wherein the amount of the photoinitiator (C) is in the range from 0.1 to 10% by weight, preferably from 0.1 to 5% by weight, more preferably from 0.1 to 3% by weight, based on the total weight of the composition.

14. The composition according to any one of items 1 to 13, which further comprises (D) a surfactant, preferably in an amount in the range from 0 to 15% by weight, preferably from 0 to 10% by weight, more preferably from 1 to 8% by weight, based on the total weight of the composition.

15. The composition according to any one of items 1 to 14, which further comprises (E) an additional additive, for example unreactive diluents and/or auxiliary agents such as pigments, fillers, dyes, and plasticizers, preferably in an amount in the range from 0 to 60% by weight, preferably from 0 to 50% by weight, more preferably from 0 to 30% by weight, based on the total weight of the composition.

16. A process of forming a 3D-printed object, comprising using the composition according to any one of items 1 to 15.

17. The process according to item 16, wherein the process comprises the steps of:
(i) applying the composition in form of a layer, and curing the applied composition layer by layer by radiation to form an intermediate 3D-printed object; and
(ii) curing the whole intermediate 3D-printed object by radiation to form a cured 3D-printed object.

18. The process according to item 17, further comprising a step of
(iii) treating the cured 3D-printed object by thermal treatment or gas blowing.

19. The process according to item 17 or 18, wherein stereolithography, photopolymer jetting, digital light processing, or LCD technology is used in step (i) to form the intermediate 3D-printed object.

20. The process according to any one of items 17 to 19, wherein the radiation is UV radiation.

21. A 3D-printed object formed from the composition according to any one of items 1 to 15 or obtained by the process according to any one of items 16 to 20.

22. The 3D-printed object according to item 21, wherein the 3D-printed object comprises sole, outerwear, cloth, footwear, toy, mat, tire, hose, gloves, seals, medical appliances such as hearing aids, dental parts.

The curable composition according to the present invention comprises a physical volatile agent. A 3D-printed object of lightweight can be successfully obtained from the composition without changing the dimension size of printed parts, while exhibiting uniform porous structure.

### DESCRIPTION OF THE DRAWING

FIG. 1 shows the SEM photograph of sample (II) obtained from the composition of example A2.

FIG. 2 shows the SEM photograph of sample (II) obtained from the composition of example B1.

FIG. 3 shows the SEM photograph of sample (II) obtained from the composition of example C₁.

FIG. 4 shows the SEM photograph of sample (II) obtained from the composition of example D.

FIG. 5 shows a photograph of sample (I) and sample (II) obtained from the composition of example A2.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

The articles “a”, “an” and “the” mean one or more of the species designated by the term following said article.

In the context of the present disclosure, any specific values mentioned for a feature (comprising the specific values mentioned in a range as the end point) can be recombined to form a new range.

Further embodiments of the present invention are discernible from the claims, the description, the examples, and the drawings. It will be understood that the aforementioned and hereinbelow still to be elucidated features of the subject matter of the present invention are utilizable not only in the particular combination indicated, but also in other combinations without leaving the realm of the present invention.

### Curable Composition

One aspect of the present invention relates to a curable composition for 3D-printing, which comprises:
(A) at least one reactive component;
(B) at least one physical volatile agent; and
(C) at least one photoinitiator.

### Reactive Component (A)

The curable composition of the present invention comprises at least one reactive component as component (A). Generally, reactive components usable for 3D-printing may be used in the present invention as reactive component (A). Preferably, reactive components suitable for the present invention may contain at least one radiation-curable functional group.

In an embodiment of the present invention, reactive component (A) of the present invention comprises a monomer and/or oligomer containing at least one radiation-curable functional group.

Preferably, the radiation-curable functional group of reactive component (A) of the present invention is selected from the group consisting of an ethylenically unsaturated functional group, an epoxy group, or the mixture thereof. For example, the at least one radiation-curable functional group of the monomer and/or oligomer containing at least one radiation-curable functional group suitable as reactive component (A) is selected from the group consisting of an ethylenically unsaturated functional group, an epoxy group, or the mixture thereof.

Preferably, the number of the radiation-curable functional group in reactive component (A) is in the range from 1 to 12, preferably from 1 to 10, such as from 1 to 8, per molecule of reactive component (A).

As reactive component (A) containing at least one epoxy group, non-limiting examples may include epoxidized olefins, aromatic glycidyl ethers, aliphatic glycidyl ethers, or the combination thereof, preferably aromatic or aliphatic glycidyl ethers.

Examples of possible epoxidized olefins include epoxidized C₂-C₁₀-olefins, such as ethylene oxide, propylene oxide, iso-butylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α, ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

More preferably, reactive component (A) of the present invention contains at least one ethylenically unsaturated functional group.

In an embodiment of the invention, the ethylenically unsaturated functional group contains a carbon-carbon unsaturated bond, such as those found in the following functional groups: allyl, vinyl, acrylate, methacrylate, acryloxy, methacryloxy, acrylamido, methacrylamido, acetylenyl, maleimido, and the like; preferably, the ethylenically unsaturated functional group contains a carbon-carbon unsaturated double bond.

In a preferred embodiment of the invention, reactive component (A) of the present invention contains, in addition to the ethylenically unsaturated functional group and/or epoxy group, urethane groups, ether groups, ester groups, carbonate groups, and any combination thereof.

As reactive component (A) of the present invention, the oligomer containing at least one radiation-curable functional group includes, for example, oligomers containing a core structure linked to the ethylenically unsaturated functional group, optionally via a linking group. The linking group can be an ether, ester, amide, urethane, carbonate, or carbonate group. In some instances, the linking group is part of the ethylenically unsaturated functional group, for instance an acryloxy or acrylamido group. The core group can be an alkyl (straight and branched chain alkyl groups), aryl (e.g., phenyl), polyether, polyester, siloxane, urethane, or other core structures and oligomers thereof. Suitable ethylenically unsaturated functional group may comprise groups containing carbon-carbon double bond, such as methacrylate groups, acrylate groups, vinyl ether groups, allyl ether groups, acrylamide groups, methacrylamide groups, or a combination thereof. In some embodiments, suitable oligomers comprise mono- and/or polyfunctional acrylate, such as mono (meth)acrylate, di(meth)acrylate, tri(meth)acrylate, or higher, or combination thereof. Optionally, the oligomer may include a siloxane backbone in order to further improve cure, flexibility and/or additional properties of the radiation-curable composition for 3D printing.

In some embodiments, the oligomer containing at least one ethylenically unsaturated functional group can be selected from the following classes: urethane (i.e. an urethane-based oligomer containing ethylenically unsaturated functional group), polyether (i.e. an polyether-based oligomer containing ethylenically unsaturated functional group), polyester (i.e. an polyester-based oligomer containing ethylenically unsaturated functional group), polycarbonate (i.e. an polycarbonate-based oligomer containing ethylenically unsaturated functional group), polyestercarbonate (i.e. an polyestercarbonate-based oligomer containing ethylenically unsaturated functional group), epoxy (i.e. an epoxy-based oligomer containing ethylenically unsaturated functional group), silicone (i.e. a silicone-based oligomer containing ethylenically unsaturated functional group) or any combination thereof. Preferably, the oligomer containing at least one ethylenically unsaturated functional group can be selected from the following classes: a urethane-based oligomer, an epoxy-based oligomer, a polyester-based oligomer, a polyether-based oligomer, polyether urethane-based oligomer, polyester urethane-based oligomer or a silicone-based oligomer, as well as any combination thereof.

In a preferred embodiment of the invention, the oligomer containing at least one ethylenically unsaturated functional group comprises a urethane-based oligomer comprising urethane repeating units and one, two or more ethylenically unsaturated functional groups, for example those containing carbon-carbon unsaturated double bond, such as (meth)acrylate groups, (meth)acrylamide groups, allyl groups and vinyl groups. Preferably, the oligomer contains at least one urethane linkage (for example, one, two or more urethane linkages) within the backbone of the oligomer molecule and at least one acrylate and/or methacrylate functional groups (for example, one, two or more acrylate and/or methacrylate functional groups) pendent to the oligomer molecule. In some embodiments, aliphatic, cycloaliphatic, or mixed aliphatic and cycloaliphatic urethane repeating units are suitable. Urethanes are typically prepared by the condensation of a diisocyanate with a diol. Aliphatic urethanes having at least two urethane moieties per repeating unit are useful. In addition, the diisocyanate and diol used to prepare the urethane comprise divalent aliphatic groups that may be the same or different.

In one embodiment, the oligomer containing at least one ethylenically unsaturated functional group comprises polyester urethane-based oligomer or polyether urethane-based oligomer containing at least one ethylenically unsaturated functional group. The ethylenically unsaturated functional group can be those containing carbon-carbon unsaturated double bond, such as acrylate groups, methacrylate groups, vinyl groups, allyl groups, acrylamide groups, methacrylamide groups etc., preferably acrylate groups and methacrylate groups.

Suitable urethane-based oligomers are known in the art and may be readily synthesized by a number of different procedures. For example, a polyfunctional alcohol may be reacted with a polyisocyanate (preferably, a stoichiometric excess of polyisocyanate) to form an NCO-terminated pre-oligomer, which is thereafter reacted with a hydroxy-functional ethylenically unsaturated monomer, such as hydroxy-functional (meth)acrylate. The polyfunctional alcohol may be any compound containing two or more OH groups per molecule and may be a monomeric polyol (e.g., a glycol), a polyester polyol, a polyether polyol or the like. The urethane-based oligomer in one embodiment of the invention is an aliphatic urethane-based oligomer containing (meth)acrylate functional group.

Suitable polyether or polyester urethane-based oligomers include the reaction product of an aliphatic or aromatic polyether or polyester polyol with an aliphatic or aromatic polyisocyanate that is functionalized with a monomer containing the ethylenically unsaturated functional group, such as (meth)acrylate group. In a preferred embodiment, the polyether and polyester are aliphatic polyether and polyester, respectively. In a preferred embodiment, the polyether and polyester urethane-based oligomers are aliphatic polyether and polyester urethane-based oligomers and comprise (meth)acrylate group.

In one embodiment, the viscosity of the oligomer containing at least one ethylenically unsaturated functional group at 60° C. can be in the range from 2000 to 100000 cP, for example 3000 cP, 4000 cP, 5000 cP, 6000 cP, 7000 cP, 8000 cP, 10000 cP, 20000 cP, 30000 cP, 40000 cP, 50000 cP, 60000 cP, 70000 cP, 80000 cP, 90000 cP, 95000 cP, preferably 4000 to 60000 cP, for example 4000 to 15000 cP, or 20000 cP to 60000 cP, as measured according to DIN EN ISO 3219.

The monomer can lower the viscosity of the composition. The monomer can be monofunctional or multifunctional (such as difunctional, trifunctional). In one embodiment, the monomer can be selected from the group consisting of (meth)acrylate monomers, (meth)acrylamide monomers, vinylaromatics having up to 20 carbon atoms, vinyl esters of carboxylic acids having up to 20 carbon atoms, α,β-unsaturated carboxylic acids having 3 to 8 carbon atoms and their anhydrides, and vinyl substituted heterocycles,

In the context of the present disclosure, term “(meth)acrylate monomer” means a monomer comprises a (meth)acrylate moiety. The structure of the (meth)acrylate moiety is as follows:

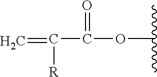

wherein R is H or methyl.

The (meth)acrylate monomer can be monofunctional or multifunctional (such as difunctional, trifunctional) (meth)acrylate monomer. Exemplary (meth)acrylate monomer can include C₁ to C₂₀ alkyl (meth)acrylate, C₁ to C₁₀ hydroxyalkyl (meth)acrylate, C₃ to C₁₀ cycloalkyl (meth)acrylate, urethane acrylate, 2-(2-ethoxy)ethyl acrylate, tetrahydrofurfuryl (meth)acrylate, 2-phenoxyethylacrylate, dicyclopentenyloxyethyl (meth)acrylate, dicyclopentadienyl (meth)acrylate, caprolactone (meth)acrylate, morpholine (meth)acrylate, ethoxylated nonyl phenol (meth)acrylate, (5-ethyl-1,3-dioxan-5-yl) methyl acrylate, phenyl (meth)acrylate, benzyl (meth)acrylate, phenethyl (meth)acrylate, dicyclopentanyl (meth)acrylate, 3,3,5-trimethylcyclohexyl (meth)acrylate and dicyclopentenyl (meth)acrylate.

Specific examples of C₁ to C₂₀ alkyl (meth)acrylate can include methyl (meth)acrylate, ethyl (meth)acrylate, isopropyl (meth)acrylate, n-propyl (meth)acrylate, n-butyl (meth)acrylate, isobutyl (meth)acrylate, tert-butyl (meth)acrylate, sec-butyl (meth)acrylate, pentyl (meth)acrylate, n-hexyl (meth)acrylate, octyl (meth)acrylate, isooctyl (meth)acrylate, 2-ethylhexyl (meth)acrylate, decyl (meth)acrylate, isodecyl (meth)acrylate, n-lauryl (meth)acrylate, n-tridecyl (meth)acrylate, n-cetyl (meth)acrylate, n-stearyl (meth)acrylate, isomyristyl (meth)acrylate, stearyl (meth)acrylate, and isostearyl (meth)acrylate (ISTA). C₆ to C₁₈ alkyl (meth)acrylate, especially C₆ to C₁₆ alkyl (meth)acrylate or C₈ to C₁₂ alkyl (meth)acrylate is preferred.

Specific examples of C₁ to C₁₀ hydroxyalkyl (meth)acrylate, such as C₂ to C₈ hydroxyalkyl (meth)acrylate can include 2-hydroxyethyl (meth)acrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate, or 3-hydroxy-2-ethylhexyl (meth)acrylate etc.

Specific examples of C₃ to C₁₀ cycloalkyl (meth)acrylate can include isobornyl acrylate, isobornyl methacrylate, cyclohexyl acrylate or cyclohexyl methacrylate.

Examples of the multifunctional (meth)acrylate monomer can include (meth)acrylic esters and especially acrylic esters of polyfunctional alcohols, particularly those which other than the hydroxyl groups comprise no further functional groups or, if they comprise any at all, comprise ether groups. Examples of such alcohols are, e.g., difunctional alcohols, such as ethylene glycol, propylene glycol, and their counterparts with higher degrees of condensation, for example such as diethylene glycol, triethylene glycol, dipropylene glycol, tripropylene glycol etc., 1,2-, 1,3- or 1,4-butanediol, 1,5-pentanediol, 1,6-hexanediol, 3-methyl-1,5-pentanediol, neopentyl glycol, alkoxylated phenolic compounds, such as ethoxylated and/or propoxylated bisphenols, 1,2-, 1,3- or 1,4-cyclohexanedimethanol, alcohols with a functionality of three or higher, such as glycerol, trimethylolpropane, butanetriol, trimethylolethane, pentaerythritol, ditrimethylolpropane, dipentaerythritol, sorbitol, mannitol, and the corresponding alkoxylated, especially ethoxylated and/or propoxylated, alcohols.

In the context of the present disclosure, term “(meth)acrylamide monomer” means a monomer comprises a (meth)acrylamide moiety. The structure of the (meth)acrylamide moiety is as follows: CH₂═CR¹—CO—N, wherein R¹ is hydrogen or methyl. Specific example of (meth)acrylamide monomer can include acryloylmorpholine, methacryloylmorpholine, N-(hydroxymethyl)acrylamide, N-hydroxyethyl acrylamide, N-isopropylacrylamide, N-isopropylmethacrylamide, N-tert-butylacrylamide, N, N′-methylenebisacrylamide, N-(isobutoxymethyl)acrylamide, N-(butoxymethyl)acrylamide, N-[3-(dimethylamino)propyl]methacrylamide, N, N-dimethylacrylamide, N, N-diethylacrylamide, N-(hydroxymethyl)methacrylamide, N-hydroxyethyl methacrylamide, N-isopropylmethacrylamide, N-isopropylmethacrylamide, N-tert-butylmethacrylamide, N, N′-methylenebismethacrylamide, N-(isobutoxymethyl)methacrylamide,

N-(butoxymethyl)methacrylamide, N-[3-(dimethylamino)propyl]methacrylamide, N, N-dimethylmethacrylamide and N,N-diethylmethacrylamide. The (meth)acrylamide monomer can be used alone or in combination.

Examples of vinylaromatics having up to 20 carbon atoms can include, such as styrene and C₁-C₄-alkyl substituted styrene, such as vinyltoluene, p-tert-butylstyrene and α-methyl styrene.

Examples of vinyl esters of carboxylic acids having up to 20 carbon atoms (for example 2 to 20 or 8 to 18 carbon atoms) can include vinyl laurate, vinyl stearate, vinyl propionate, and vinyl acetate.

Example of α, β-unsaturated carboxylic acids having 3 to 8 carbon atoms can be acrylic acid or methacrylic acid.

Examples of vinyl substituted heterocycles can include monovinyl substituted heterocycles, wherein the heterocycle is a 5- to 8-membered ring containing 2 to 7 carbon atoms, and 1 to 4 (preferably 1 or 2) heteroatoms selected from N, O and S, such as vinylpyridines, N-vinylpyrrolidone, N-vinylmorpholin-2-one, N-vinyl caprolactam and 1-vinylimidazole, vinyl alkyl oxazolidinone such as vinyl methyl oxazolidinone.

Preferred monomers are (meth)acrylate monomer, (meth)acrylamide monomer, vinylaromatics having up to 20 carbon atoms, and vinyl substituted heterocycles.

In a preferred embodiment, reactive component (A) of the present invention comprises both the oligomer and the monomer containing at least one ethylenically unsaturated functional group. The weight ratio of the oligomer to the monomer can be in the range from 10:1 to 1:10, preferably from 8:1 to 1:8, or from 5:1 to 1:5, or from 3:1 to 1:5, or from 1:1 to 1:4.

The amount of reactive component (A) can be in the range from 10 to 99.8% by weight, for example 15% by weight, 20% by weight, 25% by weight, 30% by weight, 35% by weight, 40% by weight, 45% by weight, 50% by weight, 55% by weight, 60% by weight, 70% by weight, 80% by weight, 85% by weight, 90% by weight, 92% by weight, 95% by weight, 96% by weight, 98% by weight, 99.8% by weight, preferably from 10 to 99% by weight, or 15 to 95% by weight, or 20 to 98.9% by weight, or 20 to 95% by weight, or 25 to 98.9% by weight, 30 to 98.9% by weight, 40 to 98.9% by weight, 50 to 98.9% by weight, 55 to 98.9% by weight, 40 to 95% by weight, 45 to 95% by weight, 50 to 95% by weight, based on the total weight of the composition of the present invention. Generally, the amount of reactive component (A) depends on the 3D printing machine with different requirements on viscosity etc.

### Physical Volatile Agent (B)

The curable composition of the present invention comprises at least one physical volatile agent as component (B). In the present invention, the term “physical volatile agent” means a volatile agent that will not or substantially not react with other components in the composition of the present invention, wherein “substantially” means the reaction of the physical volatile agent with other components in the composition, if occurs, will not influence the physical nature of the volatile agent and the nature of the other components for the purpose of the present invention.

The physical volatile agent (B) of the present invention may be soluble solid physical volatile agent and/or liquid physical volatile agent having a boiling point of more than 0° C. at ambient pressure. Preferably the physical volatile agent (B) of the present invention is liquid physical volatile agent having a boiling point of more than 0° C. at ambient pressure. More preferably the physical volatile agent (B) is selected from alkanes; cycloalkanes; acyclic or cyclic ethers; ketones; alkyl carboxylates; halogenated alkanes; or any combination thereof. In one embodiment, the boiling point of the physical volatile agent (B) of the present invention is more than 25° C. at ambient pressure, preferably less than 200° C. at ambient pressure.

In the present invention, the term “soluble solid physical volatile agent” means that the solid physical volatile agent may be well dispersed or dissolved into the curable composition of the present invention.

In a preferred embodiment, the physical volatile agent (B) comprises C₄₋₁₀-alkanes, preferably pentane, hexane, heptane, and octane, more preferably heptane; C₄₋₁₀-cyclo-alkanes, preferably cyclopentane, and cyclohexane; C₄₋₆-cyclic ethers, preferably furan; di-C₁₋₅-alkyl ether, preferably dimethyl ether and diethyl ether; C₄₋₁₀-cyclo-alkylene ethers; C₁₋₅-ketones, preferably acetone, methyl ethyl ketone; C₁₋₈-alkyl carboxylates, preferably methyl formate, and ethyl acetate; dimethyl oxalate; halogenated C₁₋₆-alkanes, preferably methylene chloride, trichloromethane dichloromonofluoromethane, 1,1-dichloro-2,2,2-trifluoroethane, 2,2-dichloro-2-fluoroethane, dichlorobutane and 1,5-dichloropentane; or any combination thereof.

Mixtures of the physical volatile agent with one another can also be used.

Preferably, the physical volatile agent suitable for the present invention comprises alkanes, for example C₄₋₁₀-alkanes, such as heptane.

The amount of physical volatile agent (B) can be in the range from 0.1 to 50% by weight, for example 0.1% by weight, 0.5% by weight, 1% by weight, 1.5% by weight, 2% by weight, 2.5% by weight, 3% by weight, 3.5% by weight, 4% by weight, 4.5% by weight, 5% by weight, 10% by weight, 15% by weight, 20% by weight, 25% by weight, 30% by weight, 35% by weight, 40% by weight, 45% by weight, 50% by weight, preferably from 0.1 to 45% by weight, or 1 to 45% by weight, or 1 to 40% by weight, or 1 to 30% by weight, or 1 to 25% by weight, or 1 to 20% by weight, or 2 to 35% by weight, or 2 to 25% by weight, based on the total weight of the composition of the present invention.

### Photoinitiator (C)

The curable composition of the present invention comprises at least one photoinitiator as component (C). For example, photoinitiator component (C) may include at least one free radical photoinitiator and/or at least one ionic photoinitiator, and preferably at least one (for example one or two) free radical photoinitiator. It is possible to use all photoinitiators known in the art for use in compositions for 3D-printing, e.g., it is possible to use photoinitiators that are known in the art suitable for SLA, DLP or PPJ processes.

Exemplary photoinitiators may include benzophenone, acetophenone, chlorinated acetophenone, dialkoxyacetophenones, dialkylhydroxyacetophenones, dialkylhydroxyacetophenone esters, benzoin and derivatives (such as benzoin acetate, benzoin alkyl ethers), dimethoxybenzion, dibenzylketone, benzoylcyclohexanol and other aromatic ketones, acyloxime esters, acylphosphine oxides, acylphosphonates, ketosulfides, dibenzoyldisulphides, diphenyldithiocarbonates.

For example, the free radical photoinitiator may be chosen from those commonly used to initiate radical photopolymerization. Examples of free radical photoinitiators include Irgacure® 369, Irgacure® TPO-L, benzoins, e.g., benzoin, benzoin ethers such as benzoin methyl ether, benzoin ethyl ether, benzoin isopropyl ether, benzoin phenyl ether, and benzoin acetate; acetophenones, e.g., acetophenone, 2,2-dimethoxyacetophenone, 2,2-dimethoxy-2-phenylacetophenone and 1, 1-dichloroacetophenone; benzyl ketals, e.g., benzyl dimethylketal and benzyl diethyl ketal; anthraquinones, e.g., 2-methylanthraquinone, 2-ethylanthraquinone, 2-tertbutylanthraquinone, 1-chloroanthraquinone and 2-amylanthraquinone; triphenylphosphine; benzoylphosphine oxides, e.g., 2,4,6-trimethylbenzoy-diphenylphosphine oxide (Lucirin TPO); 1 ethyl-2,4,6-trimethylbenzoylphenylphosphinate; bisacylphosphine oxides; benzophenones, e.g., benzophenone and 4,4′-bis(N,N′-dimethylamino)benzophenone; thioxanthones and xanthones; acridine derivatives; phenazine derivatives; quinoxaline derivatives; 1-phenyl-1,2-propanedione 2-O-benzoyl oxime; 4-(2-hydroxyethoxy)phenyl-(2-propyl)ketone (Irgacure® 2959); 2-methyl-1-[4-(methylthio)phenyl]-2-(4-morpholinyl)-1-propanone; 1-aminophenyl ketones or 1-hydroxy phenyl ketones, e.g., 1-hydroxycyclohexyl phenyl ketone, 2-hydroxyisopropyl phenyl ketone, phenyl 1-hydroxyisopropyl ketone, and 4-isopropylphenyl 1-hydroxyisopropyl ketone, and combinations thereof.

Specific examples of photoinitiators can include 1-hydroxycyclohexyl phenylketone, 2-methyl-1-[4-(methylthio)phenyl]-2-morpholinopropan-1-one, 2-benzyl-2-N, N-dimethylamino-1-(4-morpholinophenyl)-1-butanone, combination of 1-hydroxycyclohexyl phenyl ketone and benzophenone, 2,2-dimethoxy-2-phenyl acetophenone, bis(2,6-dimethoxybenzoy 1-(2,4,4-trimethylpentyl)phosphine oxide, 2-hydroxy-2-methyl-1-phenyl-propan-1-one, bis(2,4,6-trimethyl benzoyl) phenyl phosphine oxide, 2-hydroxy-2-methyl-1-phenyl-1-propane, 2,4,6-trimethylbenzoyldiphenyl-phosphine oxide, 2-hydroxy-2-methyl-1-phenyl-propan-1-one, 2,4,6-trimethylbenzoyldiphenylphosphinate and 2,4,6-trimethylbenzoyldiphenyl-phosphine oxide and also any combination thereof.

The amount of the photoinitiator (C) can be in the range from 0.1 to 10% by weight, for example 0.2% by weight, 0.5% by weight, 0.8% by weight, 1% by weight, 2% by weight, 3% by weight, 5% by weight, 8% by weight, or 10% by weight, preferably from 0.1 to 5% by weight or 0.1 to 3% by weight, based on the total weight of the composition of the present invention.

In one embodiment, the curable composition of the present invention comprises following components:
(A) 10 to 99.8% by weight of at least one reactive component;
(B) 0.1 to 50% by weight of at least one physical volatile agent; and
(C) 0.1 to 10% by weight of at least one photoinitiator.

In one embodiment, the curable composition of the present invention comprises following components:
(A) 20 to 98.9% by weight of at least one reactive component;
(B) 0.1 to 50% by weight of at least one physical volatile agent; and
(C) 0.1 to 10% by weight of at least one photoinitiator.

In one embodiment, the curable composition of the present invention comprises following components:
(A) 10 to 98.9% by weight of at least one reactive component;
(B) 1 to 40% by weight of at least one physical volatile agent; and
(C) 0.1 to 10% by weight of at least one photoinitiator.

In one embodiment, the curable composition of the present invention comprises following components:
(A) 10 to 98.9% by weight of at least one reactive component;
(B) 1 to 40% by weight of at least one physical volatile agent; and
(C) 0.1 to 5% by weight of at least one photoinitiator.

In one embodiment, the curable composition of the present invention comprises following components:
(A) 20 to 99.8% by weight of at least one reactive component;
(B) 0.1 to 50% by weight of at least one physical volatile agent; and
(C) 0.1 to 10% by weight of at least one photoinitiator.

In one embodiment, the curable composition of the present invention comprises following components:
(A) 20 to 99.8% by weight of at least one reactive component;
(B) 0.1 to 50% by weight of at least one physical volatile agent; and
(C) 0.1 to 5% by weight of at least one photoinitiator.

In one embodiment, the curable composition of the present invention comprises following components:
(A) 10 to 99.8% by weight of at least one reactive component;
(B) 0.1 to 50% by weight of at least one physical volatile agent; and
(C) 0.1 to 5% by weight of at least one photoinitiator.

In one embodiment, the curable composition of the present invention comprises following components:
(A) 20 to 99.8% by weight of at least one reactive component;
(B) 0.1 to 50% by weight of at least one physical volatile agent; and
(C) 0.1 to 8% by weight of at least one photoinitiator.

In one embodiment, the curable composition of the present invention comprises following components:
(A) 50 to 98% by weight of at least one reactive component;
(B) 0.1 to 50% by weight of at least one physical volatile agent; and
(C) 0.1 to 10% by weight of at least one photoinitiator.

In one embodiment, the curable composition of the present invention comprises following components:
(A) 50 to 98% by weight of at least one reactive component;
(B) 0.1 to 50% by weight of at least one physical volatile agent; and
(C) 0.1 to 5% by weight of at least one photoinitiator.

In one embodiment, the curable composition of the present invention comprises following components:
(A) 50 to 98% by weight of at least one reactive component;
(B) 1 to 40% by weight of at least one physical volatile agent; and
(C) 0.1 to 10% by weight of at least one photoinitiator.

In one embodiment, the curable composition of the present invention comprises following components:
(A) 50 to 98% by weight of at least one reactive component;
(B) 1 to 40% by weight of at least one physical volatile agent; and
(C) 0.1 to 5% by weight of at least one photoinitiator.

In one embodiment, the curable composition of the present invention comprises following components:
(A) 50 to 98% by weight of at least one reactive component;
(B) 0.1 to 50% by weight of at least one physical volatile agent; and
(C) 0.1 to 3% by weight of at least one photoinitiator.

### Surfactant (D)

Optionally, surfactant may be used in the curable composition of the present invention as component (D).

Surfactants are surface active compounds, such as anionic, cationic, nonionic and amphoteric surfactants, and mixtures thereof. Such surfactants can be used for example as dispersant, solubilizer, and the like. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate.

Suitable cationic surfactants are quaternary surfactants, for example quaternary ammonium compounds with one or two hydrophobic groups, or salts of long chain primary amines.

Suitable amphoteric surfactants are alkylbetains and imidazolines.

The amount of surfactant (D) can be in the range from 0 to 15% by weight, for example 0.1% by weight, 0.5% by weight, 1% by weight, 1.5% by weight, 2% by weight, 2.5% by weight, 3% by weight, 3.5% by weight, 4% by weight, 4.5% by weight, 5% by weight, 6% by weight, 7% by weight, 8% by weight, 9% by weight, 10% by weight, 11% by weight, 12% by weight, 13% by weight, 14% by weight, 15% by weight, preferably from 1 to 10% by weight, or 1 to 9% by weight, or 1 to 8% by weight, based on the total weight of the composition of the present invention.

### Additional Additives

For practical applications, optionally, the curable composition of the present invention may further comprise additional additives as component (E), such as unreactive diluent and/or auxiliary agent, and the like.

Suitable unreactive diluents for the present invention comprise for example (bi)cycloaliphatics such as cyclohexane and its alkylated derivatives, and also decahydronaphthalene, cyclic sulfoxides such as sulfolane, nitrogen heterocycles such as pyridine, pyrimidine, quinoline, isoquinoline, quinaldine and N-methylpyrrolidone, and also carboxamides such as N, N-dimethylformamide and N,N-dimethylacetamide.

As auxiliary agents, mention may be made by way of preferred example of flame retardants, nucleating agents, lubricant, dyes, pigments, catalyst, UV absorbers and stabilizers, e.g., against oxidation, hydrolysis, light, heat or discoloration, inorganic and/or organic fillers, reinforcing materials and plasticizers. As hydrolysis inhibitors, preference is given to oligomeric and/or polymeric aliphatic or aromatic carbodiimides. To stabilize the cured material of the invention against aging and damaging environmental influences, stabilizers are added to system in preferred embodiments.

If the composition of the invention is exposed to thermo-oxidative damage during use, in preferred embodiments, antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliary agents may be found in the specialist literature, e.g. in Plastics Additive Handbook, 5th edition, H. Zweifel, ed, Hanser Publishers, Munich, 2001.

Plasticizers can be used to lower the glass transition temperature (Tg) of the polymer. Plasticizers work by being embedded between the chains of polymers, spacing them apart (increasing the “free volume”), and thus lowering the glass transition temperature of the polymer and making it softer.

Plasticizers can be selected by a skilled person for the present invention according to practical applications. Exemplary plasticizers include C₃-C₁₅, preferably C₃-C₁₀ polycarboxylic acids and their esters with linear or branched C₂-C₃₀, preferably C₄-C₂₀, more preferably C₄-C₁₂ aliphatic alcohols. Nonlimiting examples of these plasticizers can include sebacic acid, sebacates (such as dibutyl sebacate (DBS)), adipic acid, adipates (such as bis(2-ethylhexyl)adipate (DEHA)), glutaric acid, glutarates, phthalic acid, phthalates (such as bis(2-ethylhexyl) phthalate (DEHP)), azelaic acid, azelates, maleic acid, maleates (such as dibutyl maleate (DBM)), citric acid and its derivatives, see for example WO 2010/125009, incorporated herein by reference.

Other preferred plasticizers are selected from the group consisting of benzoates; epoxidized vegetable oils; sulfonamides, such as N-ethyl toluene sulfonamide (o/p ETSA), ortho- and para-isomers, N-(2-hydroxypropyl) benzene sulfonamide (HP BSA), N-(n-butyl) benzene sulfonamide (BBSA-NBBS); organophosphates, such as tricresyl phosphate (TCP), tributyl phosphate (TBP); glycols/polyether and their derivatives, such as triethylene glycol dihexanoate (3G6, 3GH), tetraethylene glycol diheptanoate (4G7); polymeric plasticizer, such as epoxidized oils of high molecular weight and polyester plasticizers, polybutene and polyisobutylene.

In alternative embodiment, the plasticizers can be biodegradable plasticizers, such as those used as food additives, and those used in food packaging, medical products, cosmetics and children toys.

The plasticizers may be used in combination or individually in the present invention.

In a preferred embodiment, the plasticizers can be selected from the group consisting of cyclohexane dicarboxylic acid and its esters, preferably esters of 1,2-cyclohexane dicarboxylic acid, more preferably 1,2-cyclohexane dicarboxylic acid diisononyl ester (such as Hexamoll® DINCH from BASF SE).

When present, the amount of the additional additive(s) in the curable composition of the present invention may be in the range from 0 to 60% by weight, for example 5% by weight, 10% by weight, 15% by weight, 20% by weight, 25% by weight, 30% by weight, 35% by weight, 40% by weight, 50% by weight, 60% by weight, preferably from 0 to 50% by weight, or from 0 to 30% by weight, based on the total weight of the composition of the present invention.

### Preparation of the Composition

One aspect of the present invention relates to a process of preparing the curable composition of the present invention for 3D-printing, comprising mixing the components of the composition.

According to an embodiment of the invention, the mixing can be carried out at room temperature with stirring. There is no particular restriction on the time of mixing and rate of stirring, as long as all components are uniformly mixed together. In a specific embodiment, the mixing can be carried out at 1000 to 3000 RPM, preferably 1500 to 2500 RPM for 5 to 60 min, more preferably 6 to 30 min.

### 3D-Printed Object and Preparation Thereof

One aspect of the present invention relates to a process of forming 3D-printed object, comprising using the curable composition of the present invention.

In one embodiment of the present invention, the process of forming a 3D-printed object comprises the steps of:
(i) applying the composition in form of a layer, and curing the applied composition layer by layer by radiation to form an intermediate 3D-printed object; and
(ii) curing the whole intermediate 3D-printed object by radiation to form a cured 3D-printed object.

According to the invention, the curing time in step (i) and (ii) may be determined respectively by a skilled person according to practical application. For example, in step (i) of the process, the curing time for each layer may be from 0.5 to 10 s, such as from 0.6 to 6 s.

In step (ii) of the process, there is no specific restriction on the curing time for the whole intermediate 3D-printed object, as long as it is enough for curing the whole intermediate 3D-printed object. According to practical conditions (such as the size of the intermediate 3D-printed object to be cured and the curing energy employed), a skilled person will select an appropriate time for curing.

There is no specific restriction on the temperature during step (i) or step (ii). Specifically, the temperature may be selected depending on the material and the 3D printer used.

In one embodiment of the present invention, the process of forming a 3D-printed object further comprises a step of (iii) treating the cured 3D-printed object by thermal treatment or gas blowing. For example, the thermal treatment may be carried out at the temperature of 40 to 200° C., preferably 60 to 180° C., such as 60 to 160° C., 90 to 150° C., more preferably 100 to 140° C., for a time sufficient for removing the physical volatile agent.

In an embodiment of the present invention, during step (iii), the cured 3D-printed object is treated with gas blowing in a hood.

The curable composition of the present invention may be cured by radiation, such as actinic ray that has sufficient energy to initiate a polymerization or cross-linking reaction. The actinic ray can include but is not limited to α-rays, γ-rays, ultraviolet radiation (UV radiation), visible light, and electron beams, wherein UV radiation and electron beams, especially, UV radiation is preferred.

In a specific embodiment, the wavelength of the radiation light can be in the range from 350 to 420 nm, for example 355 nm, 365 nm, 385 nm, 395 nm, 405 nm, 420 nm.

Stereolithography (SLA), digital light processing (DLP), photopolymer jetting (PPJ), LCD technology or other techniques known by a person skilled in the art can be employed in step (i) of the process of forming 3D-printed objects of the present invention. Preferably, the production of cured 3D objects of complex shape is performed for instance by means of stereolithography, which has been known for a number of years. In this technique, the desired shaped article is built up from a radiation-curable composition with the aid of a recurring, alternating sequence of two steps (1) and (2). In step (1), a layer of the radiation-curable composition, one boundary of which is the surface of the composition, is cured with the aid of appropriate imaging radiation, preferably imaging radiation from a computer-controlled scanning laser beam, within a surface region which corresponds to the desired cross-sectional area of the shaped article to be formed, and in step (2) the cured layer is covered with a new layer of the radiation-curable composition, and the sequence of steps (1) and (2) is often repeated until the desired shape is finished.

The present invention further relates to a 3D-printed object formed from the curable composition of the present invention or obtained by the process of the present invention.

The 3D-printed objects can include sole, outerwear, cloth, footwear, toy, mat, tire, hose, gloves, seals, medical appliances such as hearing aids, dental parts.

The 3D-printed object of the present invention has reduced density, stable dimension size, and uniform porous structure.

### EXAMPLES

The present invention will be better understood in view of the following non-limiting examples.

### Materials and Abbreviation

### Component (A):

Bomar® BR-744SD: a difunctional, aliphatic polyester urethane acrylate from Dymax, its viscosity at 60° C. is 7000 cP;
iso-Decyl Acrylate (IDA);
Vinyl methyl oxazolidinone (VMOX) from BASF;
4-Hydroxybutyl acrylate (HBA) from BASF;
Acryloylmorpholine (ACMO); and
EBECRYL® 8413 from Allnex.

### Component (B)

Heptane from Aldrich-Sigma.

### Component (C)

Photoinitiator: 2,4,6-trimethylbenzoyldiphenylphosphine oxide (TPO) from IGM.

### Component (D)

Niax Silicone L6900 from Momentive
Tegostab® B8498, from Evonik
Dabco® DC193, from Evonik

### Examples A, A1, A2, A3, B, B1, C, C1 and D

### 1. Preparation of the Curable Compositions

The curable compositions of examples A, A1, A2, A3, B, B1, C, C1 and D were prepared by adding all components in amounts as shown in table 1 into a plastic vial and mixing by speed-mixer at 2000 RPM for 10 minutes at 25° C. The amounts in table 1 are provided in parts by weight.

Among these examples, examples A1, A2, A3, B1 and C1 are inventive examples, and examples A, B, C and D are comparative examples.

### 2. Preparation of the 3D-Printed Object

The curable compositions of examples A, A1, A2, A3, B, B1, C, C1 and D were casted respectively under UV irradiation, to stimulate a 3D-printing process and obtain a 3D-printed object.

In particular, in the examples, the 3D-printed object was prepared by a process comprising:
1. casting a curable composition by a UV-LED curing system-YW150100 (manufactured by UVPRO Co., Ltd.) at 25° C. for 0.1 min, wherein the wavelength of the LED light source was 405 nm; track speed was 3 m/min; the energy for each pass was 1298 mJ/cm²; the pass was repeated four times, to form a dumbbell-shaped intermediate 3D-printed object sample;
2. curing the intermediate 3D-printed object sample from step 1 by a NextDent™ LC-3DPrint Box for 60 min, wherein 12 lamps with a power of 18 W (6 lamps having color numbers 71 & 6 lamps having color numbers 78) were used in this step, to form a dumbbell-shaped cured 3D-printed object sample (sample (I)); and
3. treating the cured 3D-printed object from step 2 under 110° C. for 1 hr to form a post-treated cured 3D-printed object sample (sample (II)).

### 3. Test of the Prepared 3D-Printed Object

### Density

The density of a post-treated cured 3D-printed object sample (sample (II)) from each example was measured by ASTM-D-792. Results were shown in table 1.

### Morphology

To study the morphology of a 3D-printed object of the present invention, SEM photographs of sample (II) obtained from compositions A2, B1, C1 and D were provided, using ZEISS Super55 scanning electron microscope (SEM).

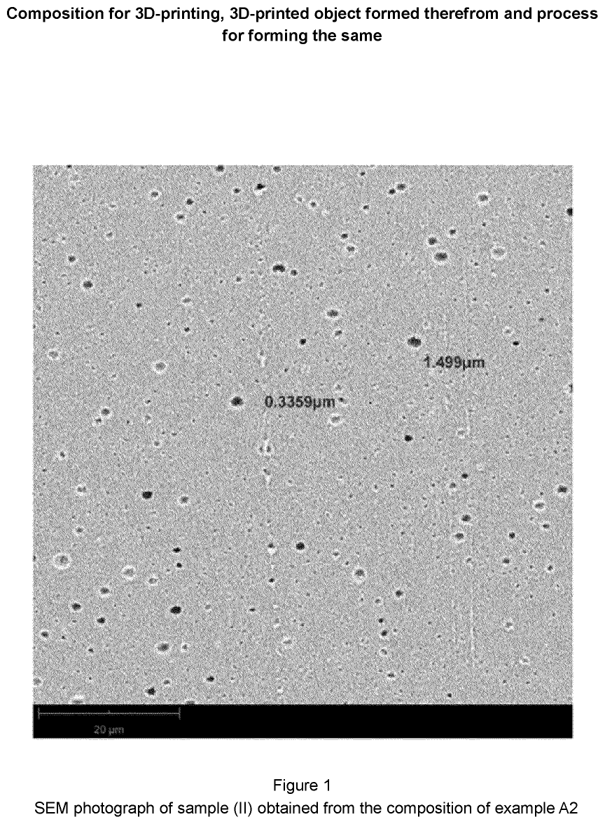

FIG. 1 shows the SEM photograph of sample (II) obtained from the composition of example A2 which shows small holes and a uniformly distributed porous structure in the 3D-printed object.

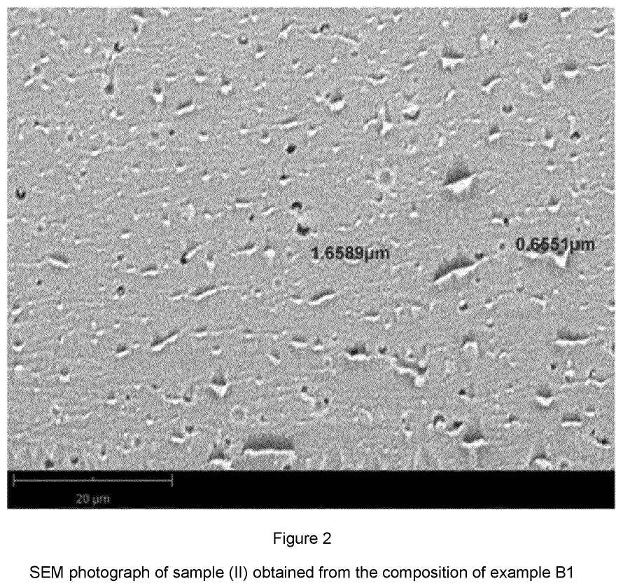

FIG. 2 shows the SEM photograph of sample (II) obtained from the composition of example B1 which shows small holes and a uniformly distributed porous structure in the 3D-printed object.

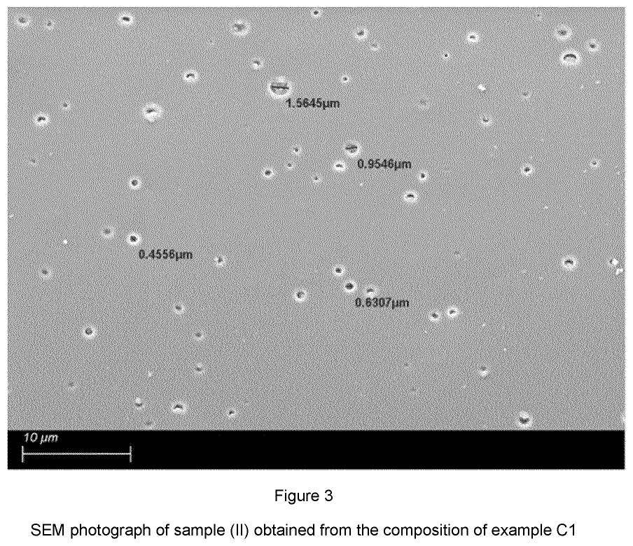

FIG. 3 shows the SEM photograph of sample (II) obtained from the composition of example C1 which shows small holes and a uniformly distributed porous structure in the 3D-printed object.

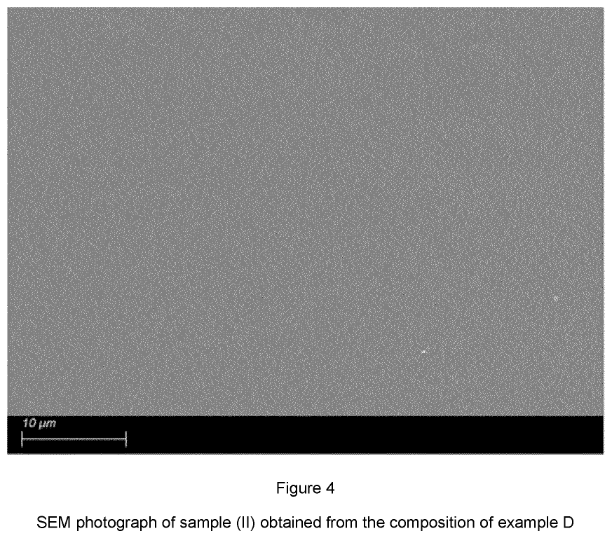

FIG. 4 shows the SEM photograph of sample (II) obtained from the composition of example D. No porous structure was formed.

### Size Stability

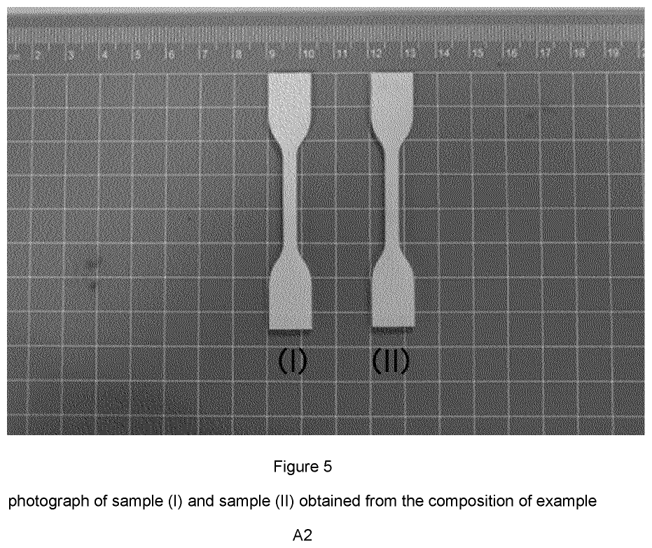

To study the size stability of a 3D-printed object of the present invention, a photograph of sample (I) and sample (II) obtained from the same procedure of the preparation of the 3D-printed object using the composition of example A2 was shown in FIG. 5.

As is shown in FIG. 5, the geometry of sample (II) obtained from step 3 of the preparation of the 3D-printed object remains almost the same to the geometry of sample (I) obtained from step 2 of the preparation of the 3D-printed object.

TABLE 1
Components and properties of examples

| | | A | A1 | A2 | A3 | B | B1 | C | C1 | D |
|---|---|---|---|---|---|---|---|---|---|---|
| Component | 8413 | 33.33 | 33.33 | 33.33 | 33.33 | 33.33 | 33.33 | | | 33.33 |
| (A) | BR-744SD | | | | | | | 30 | 30 | |
| | HBA | 33.33 | 33.33 | 33.33 | 33.33 | | | 40 | 40 | 33.33 |
| | ACMO | 33.33 | 33.33 | 33.33 | 33.33 | | | 30 | 30 | 33.33 |
| | IDA | | | | | 33.33 | 33.33 | | | |
| | VMOX | | | | | 33.33 | 33.33 | | | |
| Component | Heptane | | 5 | 10 | 20 | | 10 | | 10 | |
| (B) | | | | | | | | | | |
| Component | TPO | 2 | 2 | 2 | 2 | 2 | 2 | 2 | 2 | 2 |
| (C) | | | | | | | | | | |
| Component | L6900 | | | | | | 4 | | | |
| (D) | B8498 | | 2 | 4 | 8 | | | | | 4 |
| | DC193 | | | | | | | | 4 | |

| | | | | | | | | | |
|---|---|---|---|---|---|---|---|---|---|
| Density measured by | 1.176 | 1.150 | 1.142 | 1.057 | 1.098 | 1.085 | 1.114 | 1.069 | 1.168 |
| ASTM-D-792, g/cm³ | | | | | | | | | |

According to examples A, A1, A2 and A3, with increasing of heptane, the density of 3D-printed object was decreased from 1.176 g/cm³ to 1.057 g/cm³, with decreasing percentage of density of about 10%. According to examples B, B1, C and C1, the densities of 3D-printed objects obtained from the compositions with heptane were lower than those obtained from the compositions without heptane, which indicated that introducing heptane can prepare lightweight 3D-printed objects.

Example D is a curable composition with surfactant but without physical volatile agent. The density of the 3D-printed object obtained from the composition of example D did not decrease too much as compared with example A. According to FIG. 2, there is no porous structure in the sample (II) obtained from the composition of example D.

1.-22. (canceled)

23. A curable composition for 3D-printing, which comprises:
(A) at least one reactive component;
(B) at least one physical volatile agent; and
(C) at least one photoinitiator.

24. The composition according to claim 23, wherein the reactive component (A) contains at least one radiation-curable functional group.

25. The composition according to claim 24, wherein the radiation-curable functional group is selected from the group consisting of an ethylenically unsaturated functional group, an epoxy group, or the mixture thereof.

26. The composition according to claim 24, wherein the number of the radiation-curable functional group in the reactive component (A) is in the range from 1 to 12 per molecule of the reactive component (A).

27. The composition according to claim 23, wherein the reactive component (A) contains at least one ethylenically unsaturated functional group selected from the group consisting of allyl, vinyl, acrylate, methacrylate, acryloxy, methacryloxy, acrylamido, methacrylamido, acetylenyl, and maleimido.

28. The composition according to claim 23, wherein the reactive component (A) comprises epoxidized olefins, aromatic glycidyl ethers, aliphatic glycidyl ethers, or any combination thereof.

29. The composition according to claim 23, wherein the physical volatile agent (B) is soluble solid physical volatile agent and/or liquid physical volatile agent having a boiling point of more than 0° C. at ambient pressure.

30. The composition according to claim 29, wherein the boiling point of the liquid physical volatile agent is more than 25° C.

31. The composition according to claim 23, wherein the physical volatile agent (B) comprises C₄₋₁₀-alkanes; C₄₋₁₀-cyclo-alkanes; C₄₋₆-cyclic ethers; di-C₁₋₅-alkyl ether; C₄₋₁₀-cyclo-alkylene ethers; C₁₋₅-ketones; C₁₋₈-alkyl carboxylates; dimethyl oxalate; halogenated C₁₋₆-alkanes; or any combination thereof.

32. The composition according to claim 23, wherein the photoinitiator (C) is a free radical photoinitiator and/or an ionic photoinitiator.

33. The composition according to claim 23, wherein the amount of the reactive component (A) is in the range from 10 to 99.8% by weight, based on the total weight of the composition.

34. The composition according to claim 23, wherein the amount of the physical volatile agent (B) is in the range from 0.1 to 50% by weight, based on the total weight of the composition.

35. The composition according to claim 23, wherein the amount of the photoinitiator (C) is in the range from 0.1 to 10% by weight, based on the total weight of the composition.

36. The composition according to claim 23, which further comprises (D) a surfactant.

37. The composition according to claim 23, which further comprises (E) an additional additive selected from the group consisting of unreactive diluents pigments, fillers, dyes, plasticizers, and mixtures thereof.

38. A process of forming a 3D-printed object, comprising using the composition according to claim 23.

39. The process according to claim 38, wherein the process comprises the steps of:
(i) applying the composition in form of a layer, and curing the applied composition layer by layer by radiation to form an intermediate 3D-printed object; and
(ii) curing the whole intermediate 3D-printed object by radiation to form a cured 3D-printed object.

40. The process according to claim 39, further comprising a step of
(iii) treating the cured 3D-printed object by thermal treatment or gas blowing.

41. The process according to claim 39, wherein stereolithography, photopolymer jetting, digital light processing, or LCD technology is used in step (i) to form the intermediate 3D-printed object.

42. The process according to claim 39, wherein the radiation is UV radiation.

43. A 3D-printed object formed from the composition according to obtained by the process according to claim 38.

44. The 3D-printed object according to claim 43, wherein the 3D-printed object comprises sole, outerwear, cloth, footwear, toy, mat, tire, hose, gloves, seals, medical appliances such as hearing aids, dental parts.
